(19) United States
(12) Patent Application Publication
(10) Pub. No.: US 2009/0097183 A1
(43) Pub. Date: Apr. 16, 2009

(54) OVERVOLTAGE PROTECTION

(75) Inventor: Jozef Cernicka, Nitra (SK)

Correspondence Address: DORITY & MANNING, P.A., POST OFFICE BOX 1449, GREENVILLE, SC, 29602-1449, US

(73) Assignee: KIWA SPOL. S R.O., NITRA (SK)

(21) Appl. No.: 11/913,433

(22) PCT Filed: May 3, 2006
(86) PCT No.: PCT/IB2006/001122

§ 371 Date: Jul. 22, 2008

(30) Foreign Application Priority Data
May 4, 2005 (CZ) PV2005-283
Aug. 5, 2005 (CZ) PV2005-498

(51) Int. Cl. H02H 5/04

(52) U.S. Cl. 361/103

(57) ABSTRACT

The invention relates to an overvoltage protection comprising a bracket (1) and at least one slide-in protective member (2) which consists of at least one nonlinear resistor element and it further comprises a device for disconnecting the nonlinear resistor element from the mains and at least a part of a device for local and/or remote signalling the state of the overvoltage protection. The invention consists in that there is a sliding member (4) mounted in the body (7) of the slide-in protective member (2) in a reciprocal manner and with a pressure action against a low-melting bond of a cable (10) with an electrode (9) of the nonlinear resistor element, whereas the sliding member (4) is fitted with at least one surface for acting on a visual signalling lever (16) and it is further fitted with at least one surface for acting on a positioning element (3) of the remote signalling mounted in the bracket (1).

### TECHNICAL FIELD

The invention relates to an overvoltage protection comprising a bracket and at least one slide-in protective member which consists of at least one nonlinear resistor element and it further comprises a device for disconnecting the nonlinear resistor element from the mains and at least a part of a device for local and/or remote signalling the state of the overvoltage protection.

### BACKGROUND ART

An overvoltage protection comprises a protective element which is, as a rule, represented by a nonlinear resistor element (varistor) which gradually decreases its resistance value due to applying electric current and pulse loading to the protected mains. In consequence, the current flowing through the protective member increases, and the temperature of the protective member rises. Thus the overvoltage protection is further fitted with a temperature shutdown device. This serves to disconnect the protective member from the mains in the case of reaching a particular temperature of the protective member, because the protective member is not any further able to carry out the function properly due to its temperature rise. Disconnecting the protective member from the mains is being signalled, namely either visually directly on the overvoltage protection or by means of a transfer of a suitable signal. When it comes to disconnecting the protective member from the mains, the mains is not being protected any further, so it is necessary to renew the state of protection by exchanging the overvoltage protection protective member.

The overvoltage protection generally comprises a U-shaped bracket mounted in a supporting device and there are conductors of a protected circuit connected to it, to reach a simple replacement of the protective element. The overvoltage protection further comprises a slide-in protective member fitted with contacts for connecting to a current path arranged in the bracket and connected to protected mains whereas the slide-in protective member is slid into the bracket. Thus, the slide-in protective member is easily replaceable and there is both a nonlinear resistor element itself arranged in it and a thermal disconnecting device of the nonlinear resistor element, and a device for visual signalling the state of the overvoltage protection and, as the case may be, also suitable devices for detecting the state of the overvoltage protection for the remote signalling the change of the overvoltage protection.

There are many embodiments known, whereas their particular arrangement and used components depend on energy load and impulse current amplitude which passes through the current path of the overvoltage protection. Nowadays used embodiments depend also on manufacturing technologies used at the production of slide-in protective members. Changes in design of slide-in protective members then follow the basic goal of lowering the manufacturing costs with concurrent maintenance of required properties of overvoltage protections.

A well-known device according to Utility Design DE 295 19 313 U1 as a shutdown device of the nonlinear resistor element uses a shaped copper strip which is on one side firmly connected to a contact of the slide-in protective member and on the other side it is connected to a varistor electrode by means of thermally suitable solder. There is a hinged lever acting against the shaped copper strip, where the pressure towards the shaped copper strip is provided by means of a pressure spring which is arranged between the hinged lever and fixed (immobile) shackle of the other end of the spring. The hinged lever serves both for visual signalling the overvoltage protection status change (disconnecting the varistor from the mains) and also for acquirement the information on the status change for the remote signalling.

The drawback of this solution is in that it does not allow placing e.g. varistors connected in parallel or varistors of bigger sizes into the bushing of the slide-in protective member due to its space arrangement, which limits variability of the protective properties of this solution while maintaining the outer dimensions of the slide-in protective elements. Another drawback of this solution is the use of a sealing compound for insulation and fixation the varistor in the bushing of the slide-in protective member, which increases the costs.

Another known device according to EP 436 881 A1 utilizes the disconnecting element arrangement perpendicularly to the plane of the varistor whereas the disconnecting component is a copper strip which is on one side mounted to the contact of the slide-in protective member and it is connected on the other side to the outlet of the varistor electrode by means of thermally suitable solder. The disconnecting element is arch-shaped whereas there is a hole in its centre, into which a hinged lever reaches. The hinged lever forms the necessary action on the disconnecting element by means of the pressure spring and the disconnecting element, after the solder is melted, moves to the position in which the disconnecting of the varistor from the mains is ensured.

The drawback of this solution is the use of relatively rigid disconnecting element whose deformation for reaching the disconnection claims for a considerable action of force which sets decent demands on dimensioning in the system of used components and thus also the solution cost. Another drawback of the solution is the space arrangement of the solution which takes the inner space of the slide-in protective member body up whereas the space can be potentially used for next varistors or for another size of a varistor.

Another known device as a disconnecting element uses a copper strip which is on one of its end connected with the varistor electrode by means of thermally suitable solder and on there is a copper cable connected to its other end which is connected to the contact of the sliding member whereas there is a hinged lever reaching into the opening of the disconnecting element. The hinged lever educes action of force against the disconnecting element by means of the pressure spring.

The advantage of this solution is that the copper cable represents a flexible component which for its deformation needs only a small force, but the drawback of the solution is the increase of the number of components on the current path. This increases the number of connections which are needed to be formed during manufacturing and thus the manufacturing costs are increased.

The goal of the invention is to eliminate or at least to minimize the drawbacks of the today's background art.

### THE PRINCIPLE OF THE INVENTION

The goal of the invention has been reached by an overvoltage protection, which principle consists in that there is a sliding member mounted in a body of a slide-in protective member in a reciprocal manner and with a pressure action against a low-melting bond of a cable with an electrode of a nonlinear resistor element, whereas the sliding member is fitted with at least one surface for acting on an visual signalling lever and it is further fitted with at least one surface for acting on a positioning element of a remote signalling mounted in the bracket.

Advantages of the invention, as well as the principle and advantages of particular preferred embodiments result from the following text.

### DESCRIPTION OF THE DRAWINGS

The invention is schematically shown in the drawing where

FIG. 1 represents an arrangement of the first example of an overvoltage protection in a side view,

FIG. 2 represents an arrangement of the first example of an overvoltage protection in a perspective view,

FIG. 3a represents an example arrangement of a sliding member of FIGS. 1 and 2, FIG. 3b represents an example arrangement of a sliding member of FIGS. 1 and 2,

FIG. 4a represents an arrangement of the second example of an overvoltage protection in a perspective view, FIG. 4b represents an arrangement of the second example of an overvoltage protection in a perspective view with a cross-section of the sliding member,

FIG. 5a represents an arrangement of the third example of an overvoltage protection in a perspective view, FIG. 5b represents an arrangement of the third example of an overvoltage protection in a perspective view with a cross-section of the sliding member,

FIG. 6a represents a side cross-section of an embodiment of a slide-in protective member with a coding device and a device providing turning the slide-in protective member through 180° without affecting its function, FIG. 6b represents a view in the B direction from FIG. 6a and FIG. 6c represents a detail of an embodiment of the coding device and the device providing turning the slide-in protective member through 180° without affecting its function.

### EXAMPLES OF EMBODIMENT

Overvoltage protection consists of a bracket 1 in which there is a slide-in protective member 2 mounted in a replaceable manner. There can be a number of slide-in protective members 2 arranged side by side in one bracket 1, for instance for each phase of a three-phase power line etc. Also a plurality of single-pole brackets 1 can be connected into one assembly, e.g. by means of rivets. The bracket 1 comprises not represented terminal connectors in its arms 1a and 1b for connecting electric wires of the protected circuit. In the represented example of an overvoltage protection with a remote signalling the status change, there is the bracket 1 in its bottom part with a not represented pressure spring further comprising a positioning element 3 of the remote signalling. The bracket 1 is fitted with devices for mechanical and electrical connecting the slide-in protective member 2. The bracket 1 is fitted with current paths and contacts and the slide-in protective member 2 is fitted with contacts 5 and 6 for electrical connection of the slide-in protective member 2 and the bracket 1.

In the body 7 of the slide-in protective member 2, there is at least one nonlinear resistor element connected as a protective member, as an example a varistor 8 or a group of varistors in parallel. An outlet of a bottom electrode 9 of the varistor 8 is connected to one end of a cable 10 by means of a low-melting solder, where the cable can be, for increasing its rigidity, modified, for instance by welding individual wires forming the cable together, etc., whereas the cable 10 is on its other end connected with a contact 5 of the slide-in protective member 2. The outlet of the top electrode 11 of the varistor 8 is connected to the contact 6 of the slide-in protective member 2, for instance by means of a connecting member 12 which can be either a fixed part of the contact 6 or it can also be a separate component connected to the outlet of the top electrode 11 and to the contact 6.

There is further an identifier 13 mounted in the body 7, fitted with identifying components 13a which reach the identifier 14 on the bracket 1 in the retracted position of the slide-in protective member 2 inside the bracket 1 which confirms the proper arrangement of the bracket 1 and the slide-in protective member 2 or, as the case may be, that there is a slide-in protective member 2 of desired properties slid into the bracket 1.

In the slide-in protective member 2 body 7, there is a sliding member 4 mounted in a reciprocal manner, which is suspended directly against the cable 10 by means of a pressure spring 15, thus it acts on the low-melting bond of the cable 10 and the outlet of the bottom electrode 9 of the varistor 8. The pressure spring 15 is in the represented embodiments positioned in a cavity 4a of the sliding member 4 and it leans against the wall 7a of the slide-in protective member 2 body 7 and the sliding member 4 is by means of the connection of the cable 10 and the bottom electrode 9 of the varistor 8 being held in its normal position, when the pressure spring 15 is compressed.

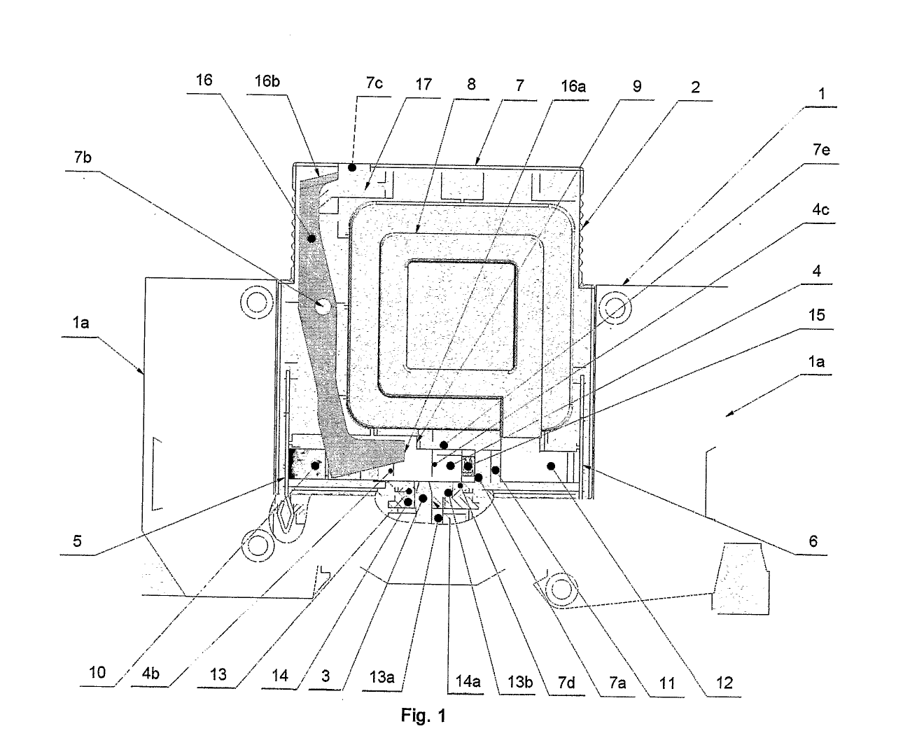

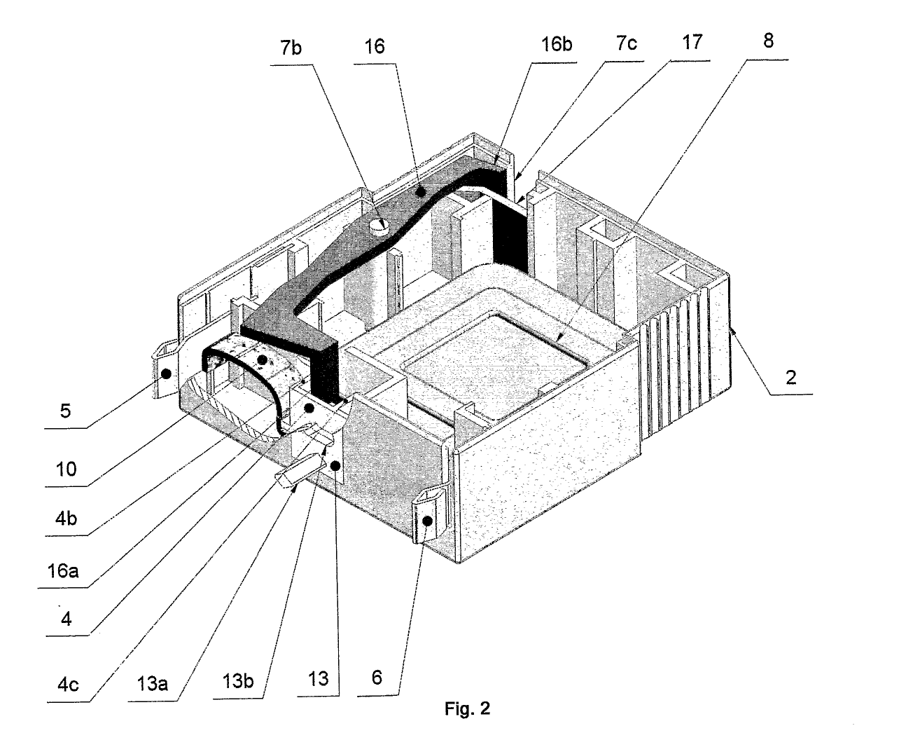

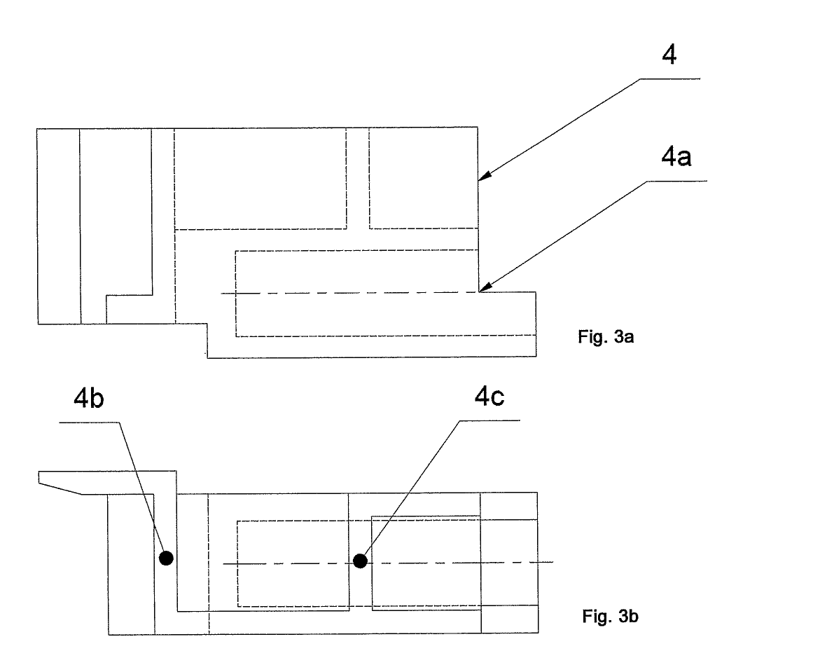

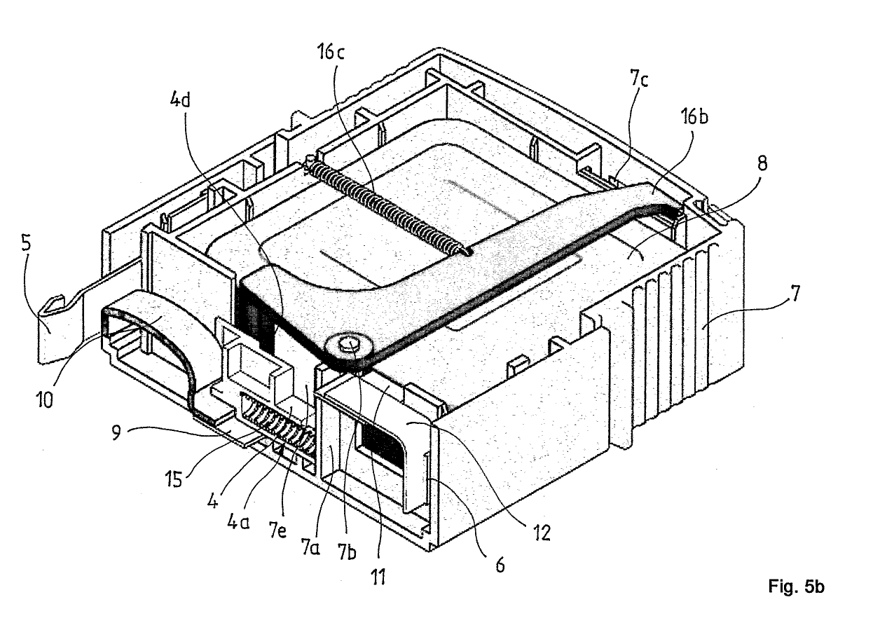

In examples shown in FIG. 1 to 4b, the sliding member 4 has between its walls 4b and 4c slid a bottom arm 16a formed on one end of a flat lever 16 which is pivoted on a stud 7b formed in the body 7 outside the floor surface of the area for the varistor 8 or varistors 8. In the example of embodiment on FIGS. 5a and 5b, there is the sliding member 4 fitted with a stepped wall 4d instead of walls 4b and 4c, against which the bottom arm 16a of the lever 16 leans, pivoted on the stud 7b formed in the body 7. The bottom arm 16a of the lever 16 is in a constant contact with the stepped wall 4d of the sliding member 4 maintained by means of a tension spring 16c which is by one of its ends mounted on the body 7 and it is connected with the lever 16 by its other end. The tension spring 16c is in the not represented embodiment replaced by means of a suitably arranged pressure spring.

The lever 16 is on its other end fitted with a signalling arm 16b fitted with a coloured spot or coloured surfaces for visual signalling the overvoltage protection state. The body 7 is for this purpose fitted with a visual signalling aperture 7c, whereas there is a spot formed in the body 7 opposite the visual signalling aperture 7c or there is an insert 17 with a colour corresponding to the visual signalling in the normal state of the overvoltage protection mounted in it, in which the signalling arm is not assigned to the aperture 7c in the body 7.

The bottom wall 7e of the body 7 and the identifier 13 are fitted with oval openings 7d and 13b through which the above described positioning element 3 passes and it is leaning against the sliding member 4. When the slide-in protective member 2 is slid in the body 1, the positioning element 3 bears in the normal position of the sliding member 4 by its end on the sliding member 4 and it mediates the information on the overvoltage protection state for the remote signalling by means of its position, which is provided by a not represented arrangement of corresponding functional components in the bracket 1. The positioning element 3 is in the shift-aside position (as described further below) of the sliding member 4 slid by one of its ends into the body 7 of the slide-in protective member 2. The identifier 13 is fitted with identifying lugs 13a interlocking into corresponding openings in the bracket 1.

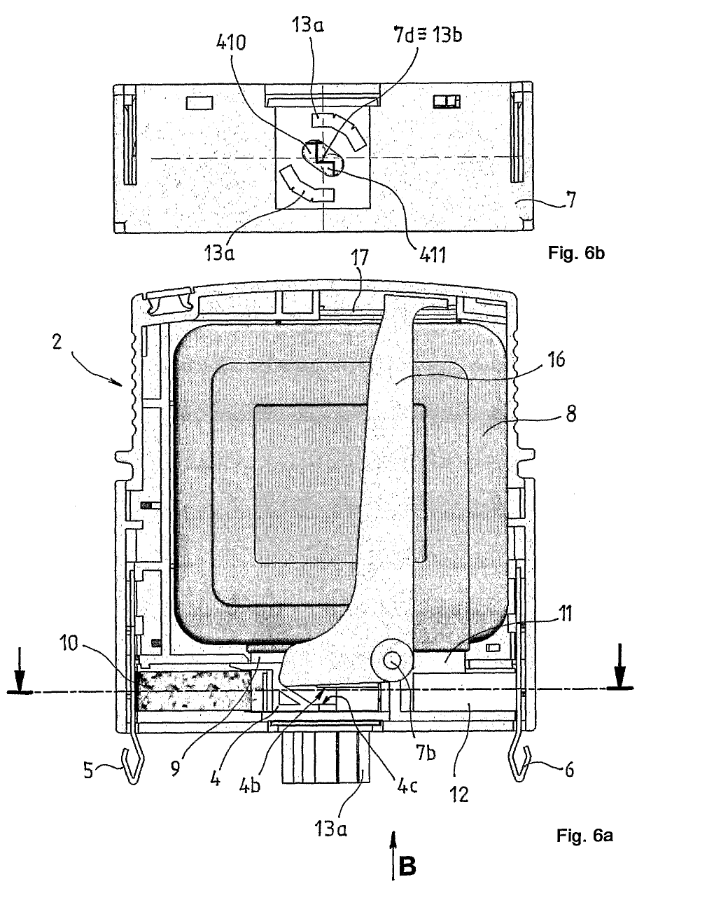

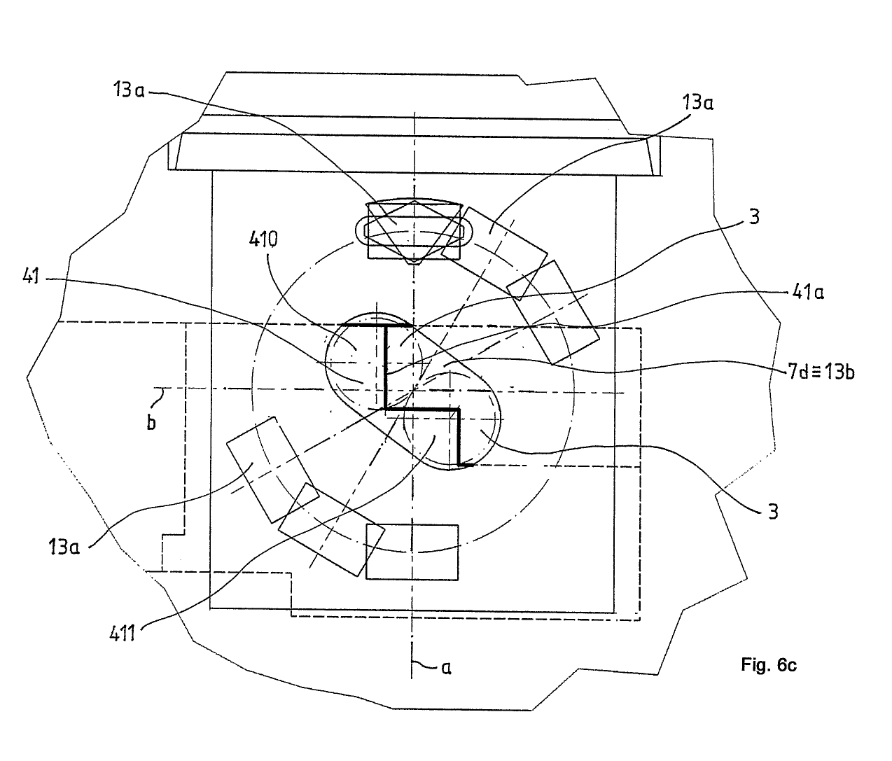

FIG. 6a to 6c represents an embodiment enabling turning the slide-in protective member 2 in the bracket 1 through 180° without affecting the protective and signalling (remote and visual) function of the slide-in protective member 2. In this embodiment, there is the positioning element 3 in the bracket situated outside the symmetry axis a of the contacts 5, 6 or outside the centre of the distance of the contacts 5, 6 and, at the same time, it is situated outside the longitudinal axis b of the slide-in protective member 2. Oval apertures 7d and 13b are situated sidelong to the axis a and also b. The sliding member 4 is fitted with a retaining wall 41 with a stepped end 41a, when in each part of sidelong oval apertures 7d and 13b, there is a part 410, 411 of the retaining wall 41 of the sliding member 4 situated. In the normal position of the sliding member 4, the end of the suspended positioning element 3 thus bears on the first part 410 of the retaining wall 41 of the sliding member 4 in one position of the slide-in protective member 2, whereas the end of the suspended positioning element 3 bears on the second part 411 of the retaining wall 41 of the sliding member 3 in the position of the slide-in protective member 2 turned through 180°. In the shift-aside position of the sliding member 4, both parts 410, 411 of the retaining wall 41 are situated outside the pathway of the suspended positioning element 3 and so they do not obstruct its sliding in sidelong oval apertures 7d and 13b into the body 7 of the slide-in protective member 2 for the remote signalling the overvoltage protection state. On the circle around sidelong arranged oval openings 7b, 13b, there are identifying lugs 13a arranged in angular spacing and they interlock in both positions of the slide-in protective member 2 (normal and also turned through 180°) into the corresponding openings in the bracket 1. In the not represented example, the slide-in protective member 2 is carried out without the possibility of turning in the bracket 1.

In examples shown in FIG. 1 to 3b, all components of the device for disconnecting the nonlinear resistor element from the mains and all overvoltage protection state signalling elements (visual and remote) are inside the body 7 of the slide-in protective element 2 situated in every state of the overvoltage protection entirely outside the area limited by the outline of the nonlinear resistor element (varistor 8) in the projection of the direction perpendicular to the side surface of the nonlinear resistor element (varistor 8), i.e. in the direction of the body 7 width. In this arrangement, it is possible to place a required number of nonlinear resistor elements (varistors 8), connected in parallel next to each other in the direction of the width of the body 7, into one type and size of the slide-in protective member 2 body 7, without the necessity to adjust the device for disconnecting the nonlinear resistor element from the mains and the device for signalling the overvoltage protection state. If there is used a smaller number of nonlinear resistor elements (varistors 8) then the maximal number is, the remaining space of the body 7 between the side wall of nonlinear resistor elements (varistors 8) and the side wall of the body 7 is clear and there is no component of the device for disconnecting the nonlinear resistor element from the mains or the overvoltage protection state signalling elements (visual and remote) reaching the clear space.

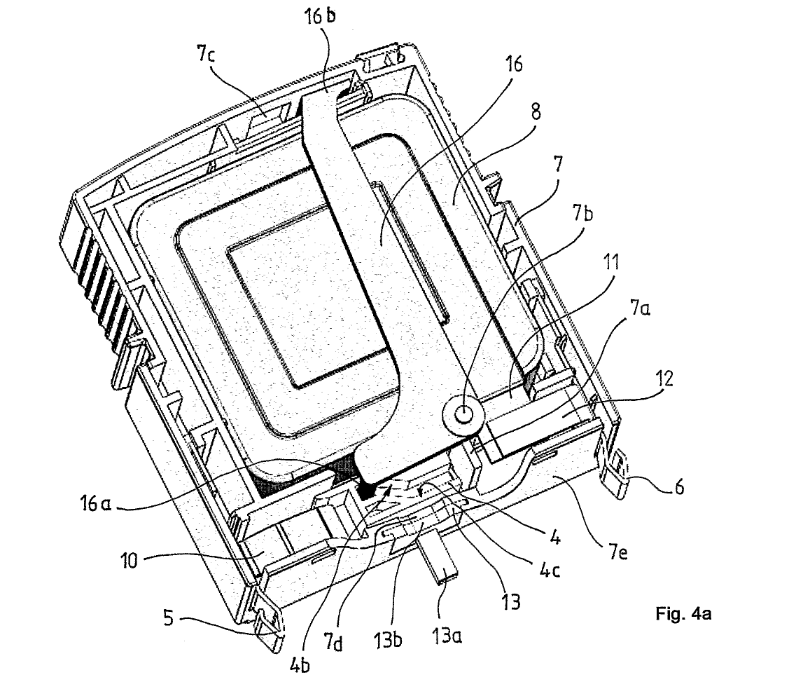

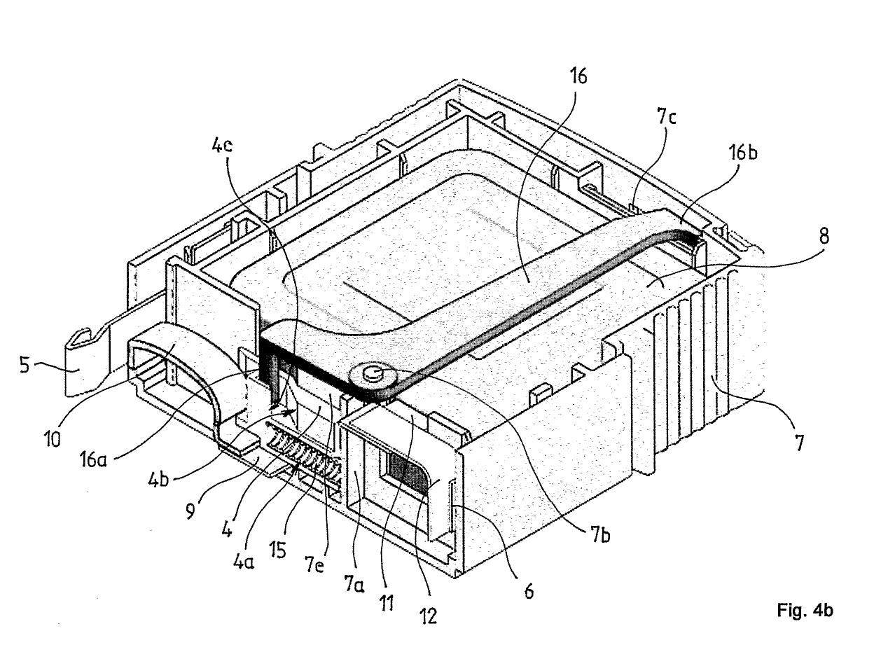

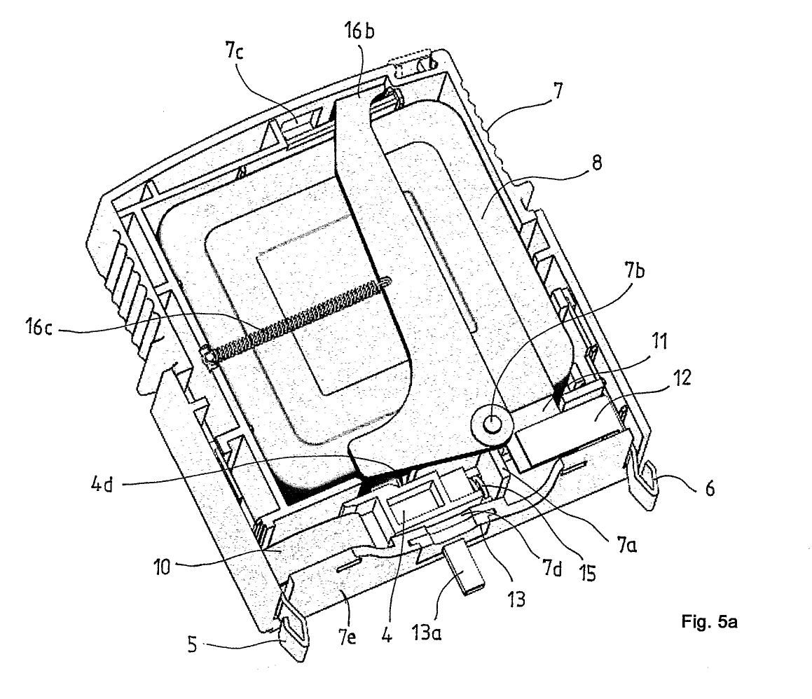

In examples shown in FIG. 4a to 5b, there is the stud 7b, on which there is the lever 16 pivoted, situated outside the space limited by the outline of the nonlinear resistor element (varistor 8) as viewed from the direction perpendicular to the side surface of the nonlinear resistor element (varistor 8, i.e. in the direction of the body 7 width, whereas the lever 16 is made flat in the direction parallel to the side wall of the nonlinear resistor element (varistor 8) and the bottom arm 16a and the signalling arm 16b are situated outside the space limited by the outline of the nonlinear resistor element (varistor 8) as viewed from the direction perpendicular to the side wall of the nonlinear resistor element (varistor 8), i.e. in the direction of the body 7 width. Also the tension spring 16c used in the example in FIGS. 5a and 5b is situated in the plane parallel to the side wall of the nonlinear resistor element (varistor 8). In the embodiment according to FIG. 4a to 5b, it is possible to arrange nonlinear resistor elements (varistors 8) of bigger sizes (and also capacities) than in FIG. 1 to 3b into the body 7 of the same outside diameters and with the same connecting means for sliding into the bracket 1, as the body 7 according to the examples on FIG. 1 to 3b has, so it is possible to use a uniform bracket 1 for both “types” of the overvoltage protections in the bodies 7 of the same outside diameters.

The overvoltage protection according to this invention operates as follows.

The overvoltage protection carries out its function regularly if there is an occurrence of an overvoltage in the protected electric circuit, i.e. it lowers the overvoltage in the protected circuit down to an admissible value. However, due to ageing and overloading the protective element (nonlinear resistor element, varistor 8, a group of varistors etc.), it comes to properties change of the protective member and as a consequence an electric current starts to flow through the protective member (varistor 8) which causes temperature rise of the protective member (varistor 8). The thermal energy is from the protective member (varistor 8) naturally being led to the outlets 9 and 11. The outlet of the bottom electrode 9 of the varistor 8 this way gradually warms up.

Due to sufficient temperature rises of the bottom electrode 9 of the varistor 8, it comes to the melting of the solder, by means of which this outlet is connected with the cable 10. In consequence, this bond looses its rigidity and the sliding member 4 starts to shift the end of the cable 10 towards the contact 5 by means of the pressure spring 15. This way it comes to disconnecting the outlet of the varistor 8 bottom electrode 9 from the cable 10 and thus also to disconnecting the protective member (varistor 8) from the mains. In the embodiment according to FIG. 1 to 3b, the movement of the sliding member 4 does not affect the position of the lever 16 in the initial phase. The wall of sliding member 4b, however, ceases to retain the lever 16 in an unscreened position, whereas by means of the next shift of the sliding member 4, the wall 4c of the sliding member 4 starts to act on the bottom arm 16a of the lever 16. The wall starts to turn the lever 16 on the stud 7b and the signalling arm 16b of the lever 16 screens the aperture 7c of the visual signalling, by means of which it comes to a change of the visual signalling of the overvoltage protection state. In the embodiment according to FIGS. 4a and 4b, the shift of the sliding member 4 causes turning the lever 16 due to the movement of the bottom end 16a in the cranked groove between the walls 4b and 4c of the sliding member 4; and the signalling arm 16b of the lever 16 screens the visual signalling aperture 7c by means of which it comes to the visual signalling change of the overvoltage protection status. In the embodiment according to FIGS. 5a and 5b, the shift of the sliding member 4 causes the turn of the lever 16 due to the stepped wall 4d of the sliding member 4, with which the bottom end 16a of the lever 16 is maintained in contact by means of the spring 16c. As a result of it, the signalling arm 16b of the lever 16 then screens the visual signalling aperture 7c which evokes the visual signalling change of the overvoltage protection status. The movement of the sliding member 4 in all these examples also causes clearing the space for protrusion of the positioning element 3 by acting of its not represented pressure spring and the positioning element 3 protrudes from which the not represented remote signalling of the overvoltage protection status change is derived. The maintenance operator then easily finds, during the inspection of the overvoltage protection from the distance or in person that the particular slide-in protective member 2 needs to be changed.

The invention is not limited only to herein explicitly described or shown embodiments but modification of the principle with the suspended sliding member 4 acting on a low-melting bond of the cable 10 and one electrode of the protected element (varistor 8) in cooperation with visual and remote signalling lies within the scope of mere professional skills of an ordinary expert in the art.

### INDUSTRIAL APPLICABILITY

The invention is applicable in protecting electric circuits from an overvoltage.

1. An overvoltage protection comprising a bracket and at least one slide-in protective member which consists of at least one nonlinear resistor element and it further comprises a device for disconnecting the nonlinear resistor element from mains and at least a part of a device for local and/or remote signaling the state of the overvoltage protection, characterized by that there is a sliding member (4) mounted in the body (7) of the slide-in protective member (2) in a reciprocal manner and with a pressure action against a low-melting bond of a cable (10) with an electrode (9) of the nonlinear resistor element, whereas the sliding member (4) is fitted with at least one surface for acting on a visual signaling lever (16) and it is further fitted with at least on surface for acting on a positioning element (3) of the remote signaling mounted in the bracket (1).

2-11. (canceled)
